(19) United States
(12) Patent Application Publication
(10) Pub. No.: US 2018/0159378 A1
(43) Pub. Date: Jun. 7, 2018

(54) INDUCTIVE POWER RECEIVER

(71) Applicant: PowerbyProxi, Auckland (NZ)

(72) Inventors: Liang Chen, Auckland (NZ); Arunim Kumar, Auckland (NZ); Aijun Qin, Auckland (NZ)

(21) Appl. No.: 15/575,319

(22) PCT Filed: May 19, 2016
(86) PCT No.: PCT/NZ2016/050079

§ 371 Date: Nov. 17, 2017

Related U.S. Application Data
(60) Provisional application No. 62/163,559, filed on May 19, 2015.
(60) Provisional application No. 62/234,553, filed on Sep. 29, 2015.

(51) Int. Cl. H02J 50/12; H02M 7/06

(52) U.S. Cl. CPC H02J 50/12; H02J 7/025; H02M 7/06

(57) ABSTRACT

An inductive power receiver comprising: a power receiving coil; a power regulation stage, configured to connect in parallel with the power receiving coil, and a tuning capacitance configured to connect in series between the power receiving coil and a rectification stage and/or a load, wherein the power regulator is configured with a short circuit control strategy.

### FIELD

This invention relates to a converter, particularly though not solely, to a converter for an inductive power receiver.

### BACKGROUND

Electrical converters are found in many different types of electrical systems. Generally speaking, a converter converts a supply of a first type to an output of a second type. Such conversion can include DC-DC, AC-AC and DC-AC electrical conversions. In some configurations a converter may have any number of DC and AC ‘parts’, for example a DC-DC converter might incorporate an AC-AC converter stage in the form of a transformer.

One example of the use of converters is in inductive power transfer (IPT) systems. IPT systems are a well-known area of established technology (for example, wireless charging of electric toothbrushes) and developing technology (for example, wireless charging of handheld devices on a ‘charging mat’).

IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver. The received power may then be used to charge a battery, or power a device or some other load associated with the inductive power receiver. Further, the transmitting coil and/or the receiving coil may be connected to a resonant capacitor to create a resonant circuit. A resonant circuit may increase power throughput and efficiency at the corresponding resonant frequency.

However currently available inductive power receivers may still suffer from significant power losses and/or large foot prints. Accordingly, the present invention may provide an improved inductive power receiver or provide the public with a useful choice.

### SUMMARY

In general terms in a first aspect the invention provides an inductive power receiver comprising:
a power receiving coil;
a power regulation stage, configured to connect in parallel with the power receiving coil, and
a tuning capacitance configured to connect in series between the power receiving coil and a rectification stage and/or a load,
wherein the power regulator is configured with a short circuit control strategy.
According to a further aspect there is provided an inductive power receiver comprising:
a power receiving coil and a tuning capacitance forming a resonant circuit;
a rectifier receiving an AC input from the resonant circuit and providing a DC output at its output terminals; and
a power regulation stage, configured to selectively connect the resonant circuit to an output terminal of the rectifier to achieve power flow control.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any documents in this specification does not constitute an admission that those documents are prior art or form part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a block diagram of an inductive power transfer system;

FIG. 2 is a block diagram of an example receiver;

FIG. 3 is a circuit diagram of an example receiver;

FIG. 4 is a series of example waveform timings for the AC switch;

FIG. 5a is a circuit diagram of an alternative AC switch;

FIG. 5b is a circuit diagram of another AC switch;

FIG. 5c is a circuit diagram of still further AC switch;

FIG. 6 is a circuit diagram of an alternative receiver; and

FIG. 7 is a series of example waveform timings for the alternative receiver.

### DETAILED DESCRIPTION

An inductive power transfer (IPT) system 1 is shown generally in FIG. 1. The IPT system includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil(s) 7 may also be considered to be separate from the inverter 5. The transmitting coil or coils 7 may be connected to capacitors (not shown) either in parallel or series to create a resonant circuit.

A controller 8 may be connected to each part of the inductive power transmitter 2. The controller 8 may be adapted to receive inputs from each part of the inductive power transmitter 2 and produce outputs that control the operation of each part. The controller 8 may be implemented as a single unit or separate units, configured to control various aspects of the inductive power transmitter 2 depending on its capabilities, including for example: power flow, tuning, selectively energising transmitting coils, inductive power receiver detection and/or communications.

The inductive power receiver 3 includes a receiving coil or coils 9 connected to power conditioning circuitry 10 that in turn supplies power to a load 11. When the coils of the inductive power transmitter 2 and the inductive power receiver 3 are suitably coupled, the alternating magnetic field generated by the transmitting coil or coils 7 induces an alternating current in the receiving coil or coils 9. The receiving coil or coils 9 may be connected to capacitors (not shown) either in parallel or series to create a resonant circuit. In some inductive power receivers, the receiver may include a controller 12 which may control tuning of the receiving coil or coils 9, operation of the power conditioning circuitry 10 and/or communications.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. The use of the term “coil”, in either singular or plural, is not meant to be restrictive in this sense. Other configurations may be used depending on the application.

The power conditioning circuitry 10 is configured to convert the induced current into a form that is appropriate for the load 11, and may include for example a power rectifier, a power regulation circuit, or a combination of both. In an example embodiment it may be desirable for the power regulation circuit to be provided in the form of shunt or short circuit control. Shunt control typically involves a switch in parallel with the load to thereby control the load voltage (compared to open circuit control where the switch is in series with the load and controls the load current). Shunt control may be provided on the AC side of the receiver or the DC load side.

Shunt control may suffer from at least two problems. First switching losses, and secondly voltage spikes occurring during switching. Zero voltage switching (ZVS) can be used to provide a solution. By switching the control switches on the AC side of the receiver when there is zero voltage across them, the switching loss and/or voltage spikes may be minimised.

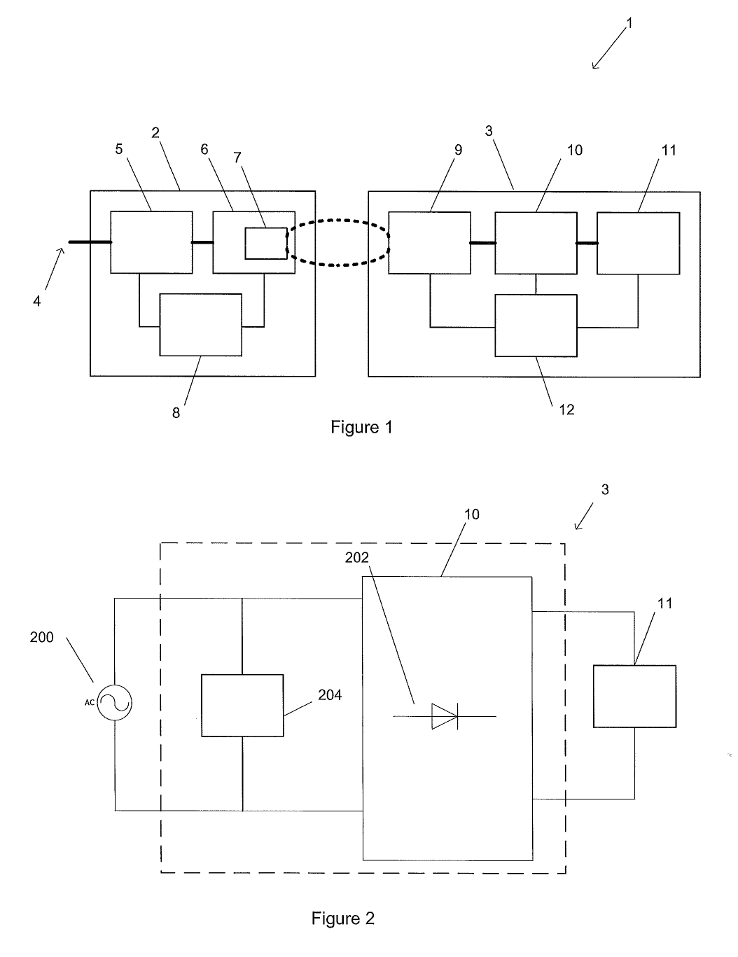

FIG. 2 shows a receiver 3 according to an example embodiment. A power regulation circuit 204 is connected in parallel with a power pick up circuit 200 and in parallel with and a power rectifier 202. The power regulation circuit 204 is driven by a controller 12 (not shown in FIG. 2) to provide ZVS shunt control.

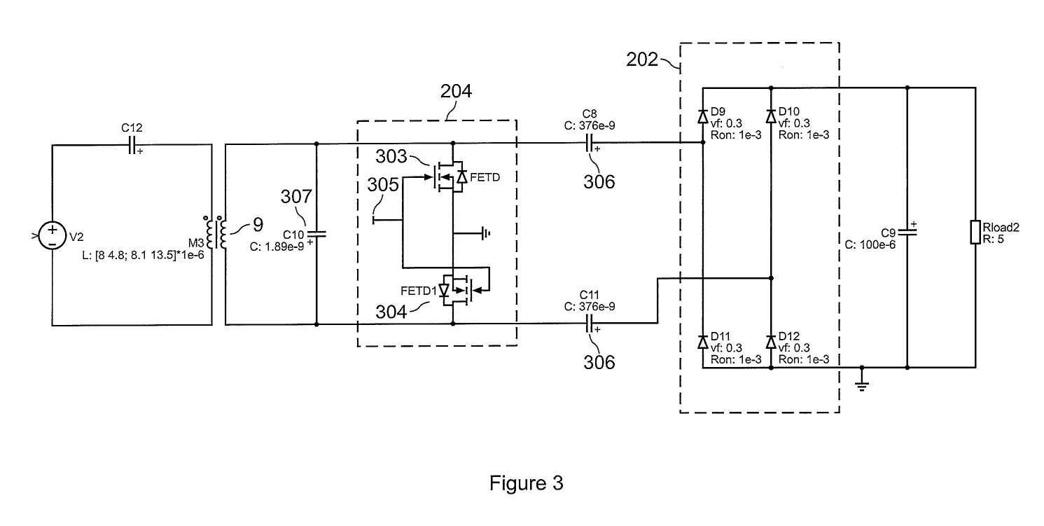

The power pick up circuit 200 is a receiving coil 9 together with a series tuning capacitance 306 as seen in FIG. 3. The series tuning capacitance 306 is provided between the power regulation circuit 204 and the power rectification circuit 202. It is split between a first capacitor in the top rail and a second capacitor in the bottom rail. The power pick up circuit 200 may be distributed around the circuit and may be interspersed with power rectifier 202 and/or power regulation 204. The series combination of the receiving coil 9 and the tuning capacitance 306 is tuned for the main IPT frequency, which depends on the application. It may be between 10 kHz to several MHz, for example 110 kHz.

FIG. 3 also shows an example power regulation circuit 204. An AC switch is connected in parallel with the receiving coil 9. An example AC switch is shown as two back to back FETs 303, 304 are connected with a common sources and their body diodes having with a common anode. The gates are connected in common and provided with a digital control signal 305 to switch hard on or hard off. In this way the FETs cannot conduct if the switch is not turned on, and when both FETs turn on, coil 9 is shorted allowing effective short circuit control. The FETs 303, 304 could be substituted with either IGBTs or BJTs with parallel diodes.

With this AC switch configuration, the centre grounding requires the series tuning capacitance 306 to be split on the bottom and top rails. The capacitors 306 are effectively in series and maintain balance between the bottom and top rails. This allows for easier gate driving of the FETs 303 and 304. If an AC switch configuration without a centre grounding were required in a given application, a single capacitance 306 could be used.

A further tuning capacitance 307 may also be present in the circuit. This provides an additional resonant frequency which may be used for communication with the transmitter. One possible means of communication is for a periodic pulse to be sent by the transmitter at the additional resonant frequency. The receiver will then resonate, presenting a load and the transmitter will detect a loss. If no loss is detected, no receiver is present.

The power rectification circuit 202 may be a full bridge rectifier or full bridge synchronous rectifier. Other rectification circuits may be employed according to the application.

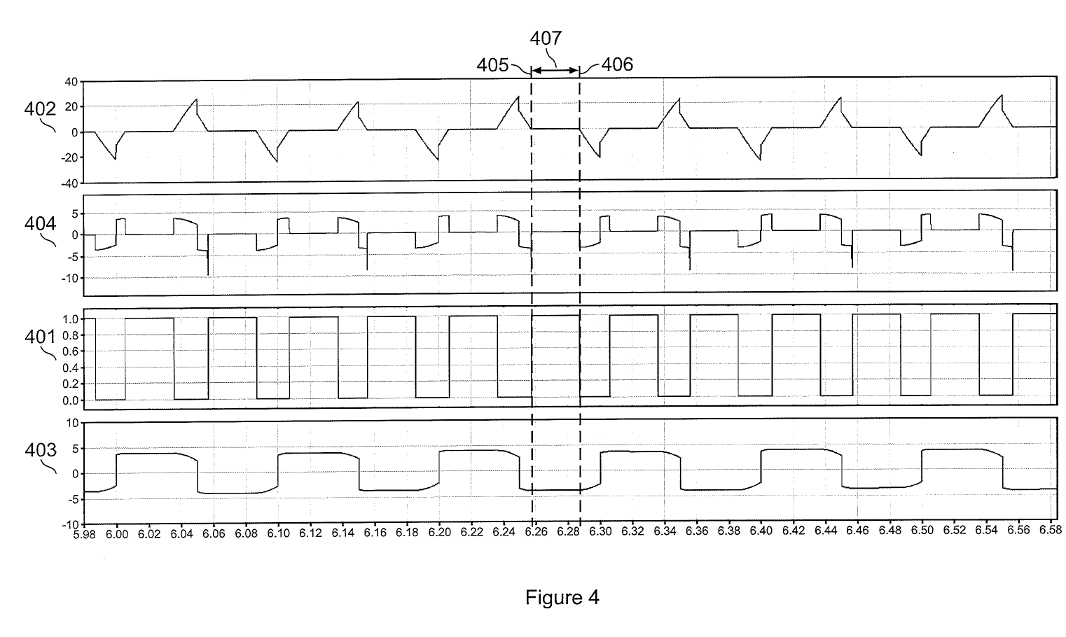

An example control strategy is now explained with the aid of FIG. 4. The AC switch is controlled by gate drive signal 401. When the voltage 402 across the switch crosses zero volts, the AC switch is turned on 405, and zero voltage switch-on is achieved, minimizing switching losses. For the duration of the AC switch being held on, the voltage 402 stays at zero. All of the current 403 through the pickup coil 9 flows through the switch and the current 404 through the tuning capacitor 306 is zero, therefore no power is transferred to the load 11. When the AC switch is turned off 406, zero voltage switch-off is achieved and the current 403 through the pickup coil 9 flows through the tuning capacitor 306 to transfer power to load 11.

Therefore the on time 407 of the AC switch determines how much current flows to the load and the amount of power transferred to the load 11 can be controlled. A shorter on time 407 means increased power transfer and vice versa. In applications where a constant output voltage is desired, a feedback loop can be set up to monitor the output voltage. The on time of the AC switch can be adjusted on a cycle by cycle basis to maintain a constant output voltage. This can be done with both analogue circuits using op-amps and digital circuits using microcontrollers.

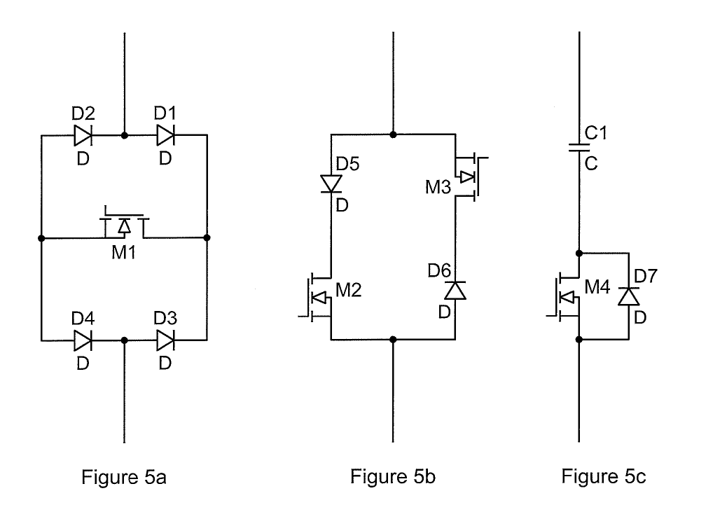

FIGS. 5a to 5c show other possible AC switch configurations. FIG. 5a shows a configuration where two sets of diodes in opposite opposing directions are connected in the centre by a switch M1. M1 can be a MOSFET, IGBT or BJT. Switching the switch M1 on would create a path to allow current to flow in both directions. With the switch M1 switched off, the separated diode pairs cannot conduct. FIG. 5b shows two sets of diodes and switches connected in parallel in opposite directions. Again, switches M2 and M3 can also be MOSFETs, IGBTs or BJTs. With the switches off, there is no current flow. When they are both on, there can be current flow in both directions. FIG. 5c uses a capacitance in series with a switch. The switch M4 can be a MOSFET or IGBT with a parallel diode.

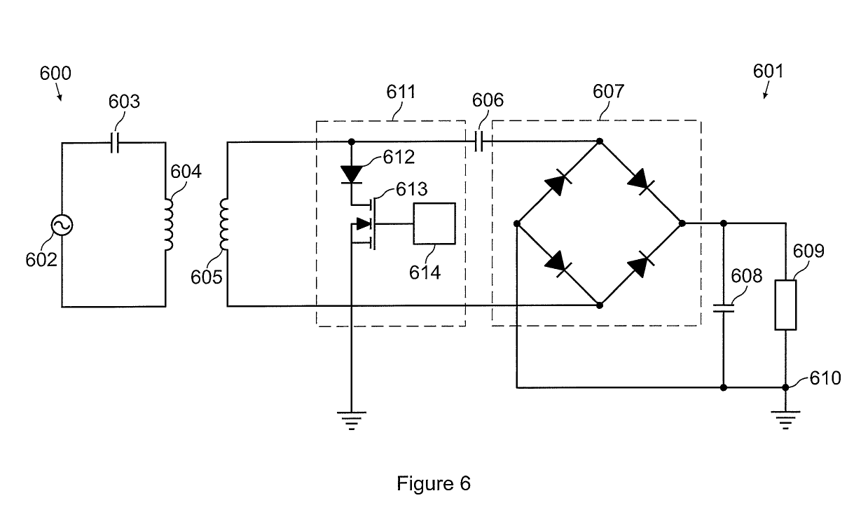

An embodiment employing an alternative power flow controller is shown in FIG. 6. The power transmitter 600 includes an AC source 602 supplying a series resonant circuit formed by capacitor 603 and transmitter coil 604. The receiver circuit includes a series resonant circuit formed by receiving coil 605 and capacitor 606 supplying an AC current to rectifier 607. A smoothing capacitor 608 and load 609 are connected to the output of rectifier 607. It will be appreciated that instead of the series resonant circuit shown in FIG. 6 that a parallel resonant circuit may be employed in which capacitor 606 is in parallel with receiving coil 605.

Power flow control is achieved by power regulator 611 shorting the receiver coil 605 to the output ground 610. By shorting to the rectifier output ground 610 the power flow control circuit may be greatly simplified. Instead of an AC switch, the power regulator 611 consists of a series connected diode 612 and a DC switch 613. When DC switch 613 is switched on it connects one terminal of the receiver coil 605 to the rectifier ground output 610. The switch may be a MOSFET or other suitable semiconductor switch. It will be appreciated that either terminal of receiving coil 605 may be shorted to either output terminal of rectifier 607 to achieve power flow control, although the implementation shown is simple to implement.

A control signal from controller 614 turns the switch 613 on and controls power flow by shorting the receiver coil 605 to ground when the rectifier output voltage exceeds a desired threshold value. In this case, only the receiver coil 605 is shorted to ground, as opposed to the tuned circuit being shorted, which, if shorted, may reflect a large impedance on the primary coil. This may prevent power flow to another receiver which is trying to draw power from the same primary source and lead to instability in the system.

The output voltage of the receiver to the load is a substantially constant DC voltage. A PID controller 614, or other suitable controller, may be used to control the output voltage. The control signal output from controller 614 may switch synchronously with the resonant circuit frequency to allow zero voltage switching. The diode 612 limits the control to the positive half of each cycle. Alternatively, the negative half of each cycle may be used, or both the positive and negative halves could be controlled (although this would add complexity).

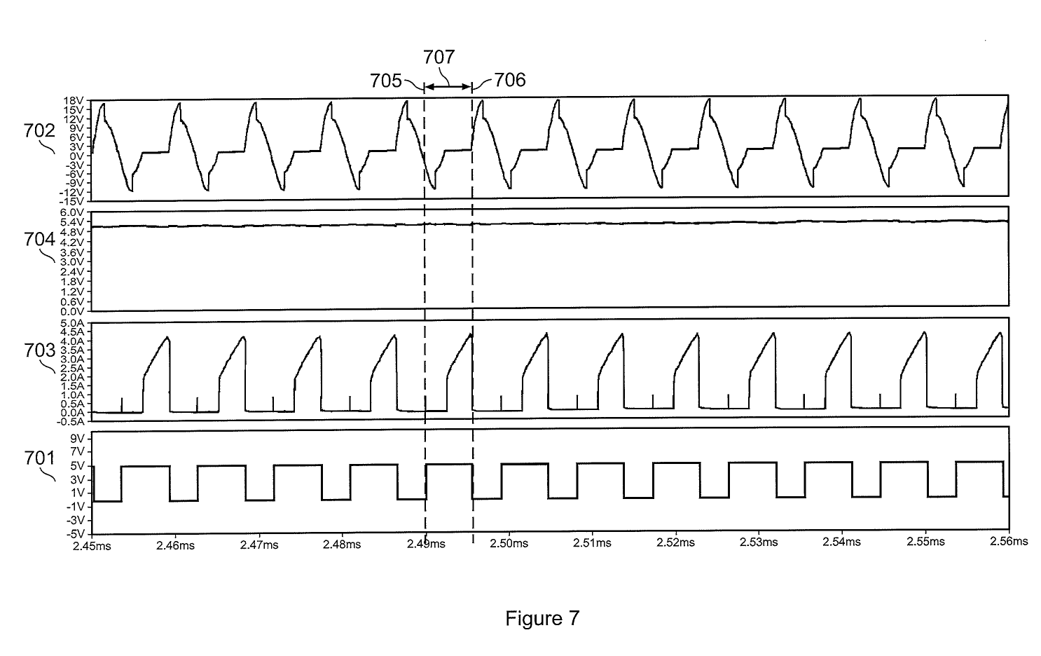

An exemplary control strategy for the embodiment shown in FIG. 6 is now explained with the aid of FIG. 7. The switch 613 is controlled by gate drive signal 701 from controller 614. When the voltage 702 at the anode of diode 612 crosses zero volts, switch 613 is turned on (see 705), and zero voltage switch-on is achieved, minimizing switching losses. The power flow controller in this case is controlling the positive half cycle, so the voltage 702 is limited while the gate drive signal 701 is high. Zero voltage switch-off is achieved when the gate drive signal is turned off 706.

The on time 707 of the switch determines how much current flows to the load and the amount of power transferred to the load 609 can be controlled. A longer on time 707 results in a lower output voltage and vice versa. The on time of the switch 613 can be adjusted on a cycle by cycle basis to maintain a constant output voltage. This can be done with both analogue circuits using op-amps and digital circuits using microcontrollers.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power receiver comprising:
a power receiving coil;
a power regulation stage, configured to connect in parallel with the power receiving coil, and
a tuning capacitance configured to connect in series between the power receiving coil and a rectification stage and/or a load, wherein the power regulator is configured with a short circuit control strategy.

2. The inductive power receiver in claim 1 wherein the power regulation stage is configured to connect between the coil and the series tuning capacitance.

3. The inductive power receiver in claim 1 wherein the power regulation stage comprises an AC switch.

4. The inductive power receiver as claimed in claim 1 wherein the AC switch includes back to back MOSFETs with a common gate and a common source.

5. The inductive power receiver in claim 2 wherein the AC switch is configured for zero voltage switch on and zero voltage switch off.

6. The inductive power receiver in claim 1 wherein the series tuning capacitance comprises two capacitors, each configured to connect between the power regulation stage and respective input terminals of a power rectification stage.

7. The inductive power receiver claim 3 wherein the shunt regulation strategy relates to determining the on time of the AC switch for each cycle at an inductive power transfer signal frequency, based on a load requirement.

8. The inductive power receiver in claim 1 further comprising a further tuning capacitor configured to connect in parallel with the power receiving coil.

9. The inductive power receiver in claim 8 wherein the parallel tuning capacitor is configured to provide a resonant frequency for a communications signal, and the series tuning capacitance is configured to provide a resonant frequency for an inductive power transfer signal.

10. An inductive power receiver comprising:
a power receiving coil and a tuning capacitance forming a resonant circuit;
a rectifier receiving an AC input from the resonant circuit and providing a DC output at its output terminals; and
a power regulation stage, configured to selectively connect the resonant circuit to an output terminal of the rectifier to achieve power flow control.

11. The inductive power receiver as claimed in claim 10 wherein the power regulation stage is connected directly to a terminal of the power receiving coil.

12. The inductive power receiver in claim 11 wherein, when switched in, the power regulation stage connects the power receiving coil to a negative output of the rectifier.

13. The inductive power receiver as claimed in claim 10 wherein the power regulation stage comprises a diode and a semiconductor switch in series.

14. The inductive power receiver as claimed in claim 10 including a controller which switches the power regulation stage based upon the DC output voltage of the receiver.

15. The inductive power receiver as claimed in claim 14 wherein the controller switches synchronously with the resonant frequency of the resonant circuit.

16. The inductive power receiver as claimed in claim 14 wherein the controller is a PID controller.

17. The inductive power receiver as claimed claim 10 wherein the resonant circuit is a series resonant circuit.

18. The inductive power receiver as claimed in claim 10 wherein the resonant circuit is a parallel resonant circuit.
